(19) United States
(12) Patent Application Publication
(10) Pub. No.: US 2014/0105215 A1
(43) Pub. Date: Apr. 17, 2014

(54) CONVERTING ADDRESSES FOR NODES OF A DATA CENTER NETWORK INTO COMPACT IDENTIFIERS FOR DETERMINING FLOW KEYS FOR RECEIVED DATA PACKETS

(71) Applicant: HEWLETT-PACKARD DEVELOPMENT COMPANY, L.P., Houston, TX (US)

(72) Inventors: Jeffrey C. Mogul, Menlo Park, CA (US); Dwight L. Barron, Houston, TX (US); Paul T. Congdon, Granite Bay, CA (US)

(73) Assignee: HEWLETT-PACKARD DEVELOPMENT COMPANY, L.P., Houston, TX (US)

(21) Appl. No.: 13/652,096

(22) Filed: Oct. 15, 2012

(51) Int. Cl. H04L 12/56

(52) U.S. Cl. 370/395.32

(57) ABSTRACT

A network switch handles a data packet by determining a plurality of address items. An identifier is determined that is singularly associated with each address item in the set, the identifier having fewer bits than the associated address item. A flow key for the packet using (i) at least some of the plurality of fields, and (ii) the identifier associated with each address item in the set, and not the associated address item.

### BACKGROUND

Many kinds of networks incorporate network switches that utilize hardware resources such as Ternary Content Addressable Memory (TCAM). TCAMs are comparatively expensive resources, consuming significant amounts of power when in operation.

One type of network that that has increasing significance is a Software-Defined Network. (SDN). An SDN network controls data flows and switching behavior using software controlled switches. An SDN, rather than putting all networking-related complexity into the individual switches, instead employs a set of relatively simple switches, managed by a central controller.

OpenFlow is a communication protocol utilized by some SDNs. In OpenFlow, the controller provides each switch with a set of “flow rules.” A flow rule consists primarily of a pattern that is matched against a flow key extracted from the fields within a packet. The flow rules specify a set of actions that should be carried out if a packet matches that rule. The flow rules also specify a set of counters that should be incremented if a packet matches the rule. OpenFlow specifies a packet counter and a byte counter for each rule.

Under conventional approaches, the flow rule is determined through a two-stage process. First, the fields of a packet are extracted to determine a flow key for a packet. A flow key can be constructed using various fields that are extracted from an individual packet, including the Level-2 and Level-3 address fields, and also including meta-data provided by other means. Second, the flow key is used to determine a flow rule from a lookup table, typically provided through a lookup table such as provided with a TCAM. Under conventional approach, the TCAM needs to have sufficient width to cover all of the bits in the flow key, and the size of the flow key is dependent on the size of the address fields. As an example, each of the IP address fields used for determining the flow key in IPv6 packets are 128 bits. These large addresses result in large flow keys, which require wide TCAMs.

### BRIEF DESCRIPTION OF THE DRAWINGS

FIG. 1 illustrates an example system for implementing data packet routing within a data center network.

FIG. 2 illustrates an example method for handling data packets within a data center network.

FIG. 3 illustrates an example method for handling data packets with wildcard designations in a data center network.

FIG. 4 illustrates an example hardware system for implementing examples such as described.

### DETAILED DESCRIPTION

Examples described herein provide for operating a switch in a data center network to convert address fields specified in the headers of received data packets into more compact identifiers. The compact identifiers that are identified for individual packets can be used to determine flow keys for the respective packets. With use of the compact identifiers rather than the address fields, the flow keys can be constructed to be smaller, thus optimizing the flow rule lookup process and reducing the requirements for hardware used to implement the flow rule look up process.

In an example, a switch for a data center network includes a processing resource and a memory. The memory stores a hash table that includes (i) numerous address items for nodes of the data center network, and (ii) an identifier corresponding to each of the address items. Each identifier is characterized by a smaller bit size than its corresponding address item, and each address item corresponds to at least a portion of an address. The processing resource operates to extract a set of fields from a received data packet. The plurality of fields includes a set of address items. The processing resource uses the hash table to convert at least some of the address items in the set of address items into the corresponding identifier. A flow key is determined for each of the received packets based at least in part on (i) at least some of the plurality of fields extracted for that data packet, and (ii) the corresponding identifier for each converted address items for that data packet.

In another example, the data packet is handled on a switch of a data center network by determining its fields, including a set of address items, where each address item corresponds to at least a portion of an address. An identifier is determined that is singularly associated with each address item of the set. The identifier may be characterized by having fewer bits than the associated address item. A flow key is determined for the packet using (i) at least some of the plurality of fields, and (ii) the identifier associated with each address item in the set, in place of the associated address item.

Examples described herein recognize and leverage certain characteristics that are present in many data centers. First, examples recognize that within a data center network, the set of possible addresses for nodes within that data center is known (or can be known), and generally, is a finite and manageable number (e.g., less than 10EXP6). As an example, each node in a data center network can be associated with a set of addresses that includes an Ethernet address and an IP address. By, for example, implementing network discovery tools, each node of the data center network can be identified, and the set of addresses associated with each particular node can be aggregated.

Examples described herein include switches, positioned within, for example, a data center network that can handle data packets that specify fields for determining flow keys for the data packets. The fields that are extracted from the individual data packets include a set of addresses (source and destination Ethernet addresses, source and destination IP addresses). Examples described herein recognize that the use of address fields can result in the need for significant lookup resources. For example, the use of address fields in determining flow keys and flow rules require resources that include larger routing tables and TCAMs. Larger TCAMs, in particular, are expensive and utilize considerable power. Reducing the lookup resources (e.g., size of the TCAM) can provide cost savings and efficiency. Accordingly, in contrast to conventional approaches, rather than using the addresses specified in a data packet to determine a flow key, examples described herein provide for the use of smaller or more compact identifiers or tags that replace the address fields for purpose of determining flow keys.

In particular, based on these recognized characteristics of data center networks, the known addresses of the data center network can be pre-associated with smaller or more compact identifiers. This allows for addresses specified in the packets handled by individual switches to be converted into smaller or more compact identifiers for purposes of determining the flow key for a given data packet.

Examples described herein can also be implemented to handle data packets that include wildcard designations in their respective IP addresses. Another characteristics recognized by the examples described herein is that, within the data center network, generally a small number of prefixes are in use for the Internet Protocol (IP) addresses of the various nodes. An assumption can be made that those outside of the data center network utilize the prefix for an IP address that is not one of the prefixes in use within the data center network. Another characteristic recognized by examples described herein is that a controller (or controllers) of a data network are able to delineate portions of the IP addresses in use as belonging to either a subnet (or prefix) or host (or suffix) address item. Wildcard designations, which are common with the use of IP addresses in data center networks, can be handled by delineating portions of the IP address that are likely to receive wildcard designations (e.g., by prefix or suffix). By assuming that a small number of prefixes are in use for the IP addresses of the various nodes, separate compact identifiers can be determined for delineated portions of the IP addresses specified in the data packets.

In examples described herein, compact identifiers are intended to include data items that represent address items, specified in data packets handled by a switch, but the compact identifiers are generally smaller in dimension than the address fields that they represent. In examples described, the compact identifiers represent a single address item (e.g., address or portion thereof) of a data center network, but utilize a significant number of fewer bits in representing the particular address item. For example, the compact identifiers of a data center network may have a size of between 15-24 bits, while the address fields that the compact identifiers represent are typically 32 bits (IPv4), 48 bits (Ethernet), or 128 bits (IPv6).

Among other benefits, examples described herein modify the manner in which a flow key is constructed for a data packet received on a network switch, as compared to conventional approaches. A switch, for example, may include packet processing logic that converts some of the address fields into smaller-sized (having fewer bits) compact identifiers. The conversion of the address fields into compact identifiers enables a flow key to be constructed for a data packet in a manner that is more efficient (e.g., smaller in dimension) as compared to flow keys that are constructed from the address fields without conversion.

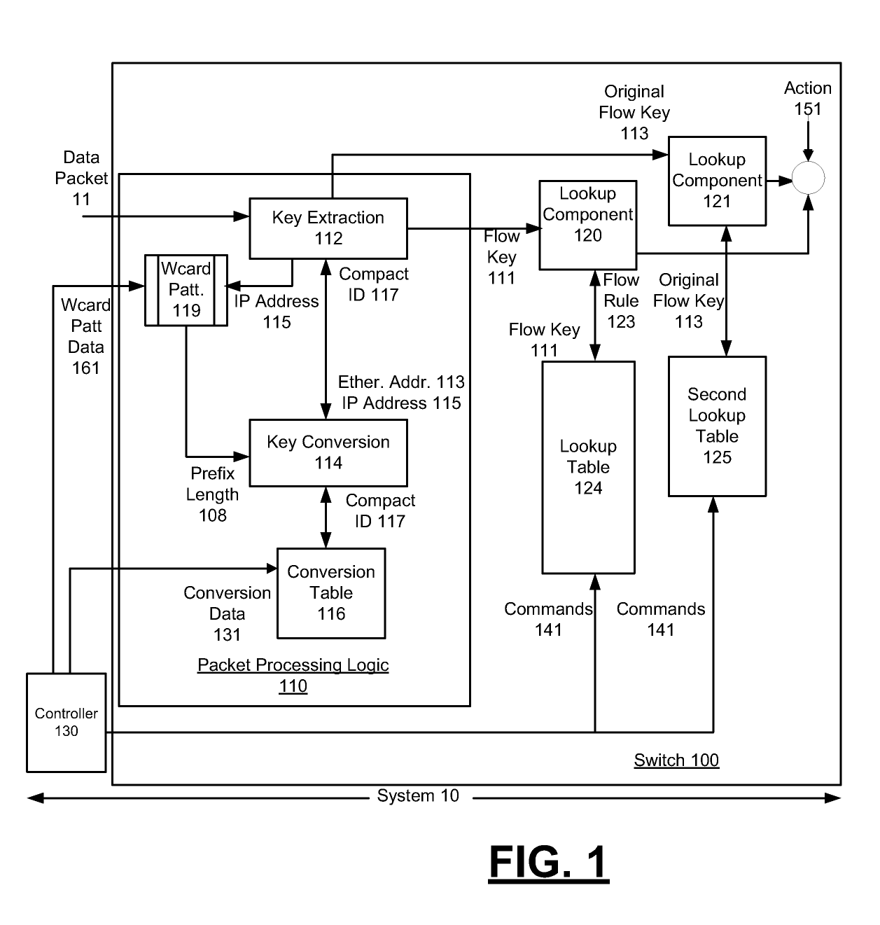

With reference to FIG. 1, one or more examples described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

One or more examples described herein provide that methods, techniques and actions performed by a computing device (e.g., node of a distributed file system) are performed programmatically, or as a computer-implemented method. Programmatically means through the use of code, or computer-executable instructions. A programmatically performed step may or may not be automatic.

System Overview

FIG. 1 illustrates an example system for implementing data packet routing within a data center network. A system 10 includes a switch 100 and a controller 130. The switch 100 and controller 130 are representative of additional switches 100 and/or controllers 130 which can be implemented as part of the system 10. In an example of FIG. 1, the switch 100 is able to utilize data provided from the controller 130 in order to convert address fields of data packets into compact identifiers. The switch 100 uses the compact identifiers to determine the flow key for individual data packets, from which the flow rule can be determined for handling and/or routing the packet. The system 10 can implement, for example, an OpenFlow communication protocol in which the controller 130 uses programmatic resources to control operations of the switch 100. The controller 130 can configure the lookup tables 124 (and second lookup table 125) with table data 141, which can include commands and statistical information.

As described with examples provided herein, the switch 100 can determine flow keys for individual incoming packets using compact identifiers. For example, the address fields of individual data packets can include each of a source and destination Ethernet addresses, as well as each of a source and destination Internet Protocol address. The size of Ethernet addresses are typically 48 bits, and the size of IP addresses are typically 32 or 128 bits, depending on whether the protocol of implementation is IPv4 or IPv6. As described with examples provided herein, the switch 100 includes packet processing logic 110 to convert the address fields of data packets into compact identifiers that can have bit sizes which range, for example, between 15-24 bits for Level-2 addresses, and 14-45 bits for Level-3 addresses (including 128 bit IP6 packets).

Accordingly, examples recognize that the number of addresses that are needed in most data center networks can be represented by a bit size that is considerably smaller than the address fields. Moreover, programmatic tools exist that enable data center controllers (or other equipment) to determine all of the Ethernet and IP addresses in use on the data center network. In most cases, each address in use with the data center network can be uniquely represented by an identifier that requires significantly fewer bits than the address fields (e.g., 15-24 bits for Level-2 addresses). In one implementation, the Ethernet and IP addresses in use on the network can be predetermined and mapped to compact identifiers, so that the address fields of the incoming packets can be converted into the compact identifiers for purpose of determining flow keys for respective data packets.

The flow key can be determined for each packet in order to determine a flow rule for how the packet is handled and routed within the data center network. Among other benefits, the use of compact identifiers in place of select address fields enables the flow key to be smaller in size, thus reducing resource requirements of the lookup components, such as the size of the lookup table or TCAM for matching the flow key to a rule.

In an example system 10, the switch 100 includes packet processing logic 110 and a lookup component 120. The packet processing logic 110 can include a key extraction component 112 that determines a compacted flow key 111 for the data packet. The lookup component 120 determines a flow rule for the packet based on the flow key 111. As described herein, the flow key 111 is generated to be more optimal for performing the lookup operations as compared to conventional approaches which use relatively large address fields to determine the flow keys.

In an example, the packet processing logic 110 includes a key extraction component 112, a key conversion component 114, and an address conversion table 116. The key extraction component 112 extracts the fields of an incoming data packet 11. The extracted fields can include, for example, source and destination Ethernet addresses, source and destination IP addresses, TCP port number, bit fields that identify whether the packet is communicated under TCP/IP or UDP protocol, bit fields that identify the VLAN number the packet was received on, the switch port number and other fields. The key extraction component 112 determines the flow key 111 for the individual packets 11 based on the compact identifiers of the address fields, as well as the other extracted fields.

More specifically, the key extraction component 112 can utilize the key conversion component 114 to convert the Ethernet and IP addresses into compact identifiers 117. Each compact identifier 117 singularly represents an address item, such as an Ethernet address, IP address or portion thereof. The key conversion component 114 can perform a lookup or match with the conversion table 116 to determine the compact identifier for individual address items extracted from the packet 11. The address items can include, for example, the source and destination Ethernet address, and at least portions (e.g., subnet and host portions) of each of the source and destination IP address.

The conversion table 116 pairs each address item, as determined from knowledge of the nodes and associated addresses in the data center network, with a corresponding compact identifier. In one implementation, the conversion table 116 is a hash table that receives and stores the address item-compact identifier pairs from, for example, the controller 130.

In one implementation, the key conversion component 114 determines, for example, four (4) compact identifiers for each of the source Ethernet address, destination Ethernet address, source IP address, and destination IP address. In some implementations, common wildcard designations are also handled by determining separate compact identifiers for the subnet (prefix) and host (suffix) portions of each IP address, so that, for example, six (6) compact identifiers are determined for each data packet. The conversion table 116 can also be used to singularly map the prefix/subnet and host/suffix portions of the individual IP addresses to compact identifiers.

In this way, the key extraction component 112 determines the flow key 111 based in part on the compact identifiers 117 determined for each packet 11. The compact identifiers 117 can substitute for each corresponding address in determining the flow key 111. Thus, the flow key 111 is not expanded in size as a result of the addresses included in the packet 11, but rather is regulated in size based on the smaller bit size of the compact identifiers 117.

The packet processing logic 110 constructs the flow key 111 from the various extracted fields of the packet 11. But in contrast to conventional approaches, the packet processing logic 110 converts the address fields into compact identifiers 117, and uses the compact identifiers 117 instead of the larger address fields when determining the flow key 111 for the packet 11. The flow key 111 can correspond to, for example, a single pattern that is used to perform a lookup for a flow rule. The lookup component 120 uses the flow key 111 to determine a flow rule 123 for the packet 11 from the lookup table 124. In one implementation, the lookup table 124 is implemented using a TCAM. The flow rule 123 can specify, for example, the routing and handling of the packet to be applied to the packet by the switch 100. In some implementations, the flow rule 123 can specify an action 151 that the switch 100 is to apply to the packet.

An example of FIG. 1 can be implemented based on recognition that each address associated with a node of the data center network can be known in advance. By determining the addresses of individual nodes in the data center network, a mapping or conversion scheme can be determined to convert address fields for incoming packets to compact identifiers that are smaller in bit size. With regard to examples such as provided by FIG. 1, the controller 130 can determine the addresses of the numerous physical or virtual nodes of the network using, for example, a network discovery tool. In one implementation, the controller 130 determines a compact identifier for each determined address. The controller 130 can update the conversion table 116 with conversion data 131. The conversion data 131 can include, for example, a data pair that matches each address item (e.g., Ethernet address, IP address, subnet/prefix portion of IP address, host/suffix portion of IP address) to a compact identifier.

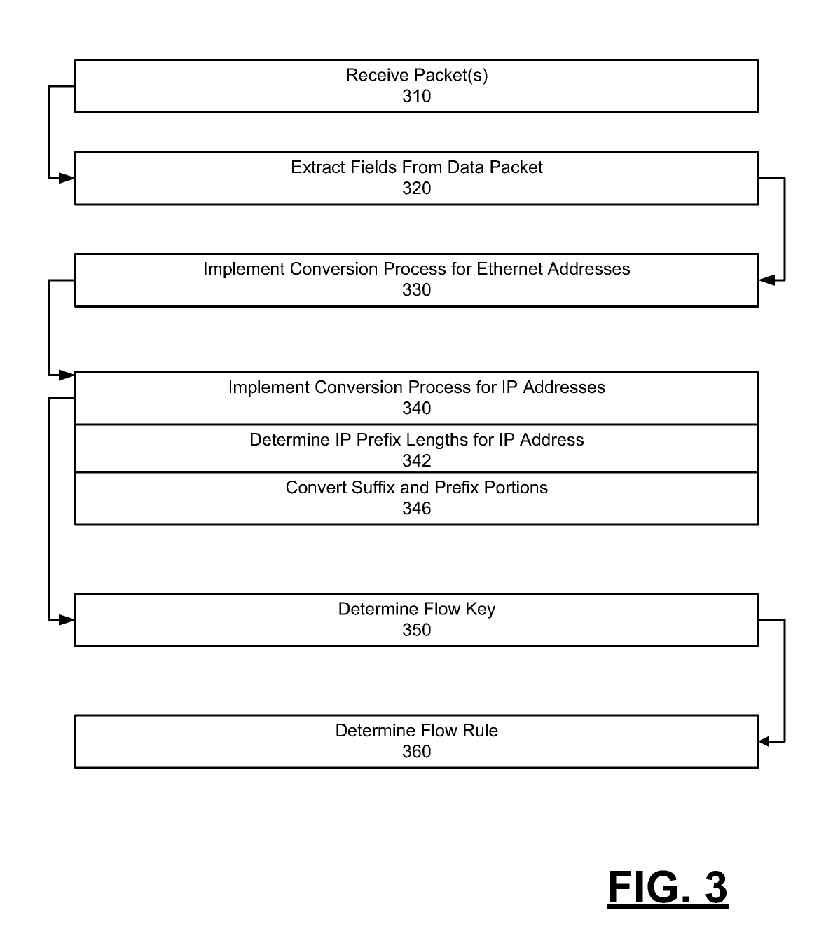

The controller 130 can include logic or data to determine delineations in addresses that are in use in the data center network. For example, the controller 130 can maintain information that determines the subnet (prefix) and host (suffix) designations in the IP addressing of the data center network. As described with an example of FIG. 3, the designation of portions of IP addresses as being subnet (or prefix) or host (or suffix) permit compact identifiers to be used in cases where the packets include wildcard designations in their respective IP address fields. Specifically, the subnet and host portions of each source and destination IP address can be predetermined, and the conversion process can be implemented for each of the subnet and host portions of the respective IP addresses. In one implementation, a prefix length determination 108 can be made using logic such as a wildcard pattern table 119. The wildcard pattern table 119 can be used in connection with the IP addresses 115 (both source and destination) specified in the data packets 11. The wildcard pattern table 119 can receive wildcard pattern data 161 from the controller 130. In this way, wildcard pattern table 119 can be used to determine prefix lengths 108 for the IP addresses 115 specified in the packets 11. The prefix length 108 identifies an appropriate prefix length for an address specified in the packet 11. In other variations, the data center network may utilize only a single prefix length.

In a variation, the conversion table 116 can be replicated within the switch 100, so that each address item extracted from the packet 11 can be converted separately. For example, the packet processing logic 110 of the switch 100 can pipeline the conversion of each address item (e.g., Ethernet addresses, IP addresses and/or designated portions) using replicated hash tables that correspond to the conversion table 116. As an addition or variation, the conversion table 116 can be implemented as separate tables for converting Ethernet and IP addresses, respectively, in parallel, and without having to waste table space to store addresses of several sizes in a single table.

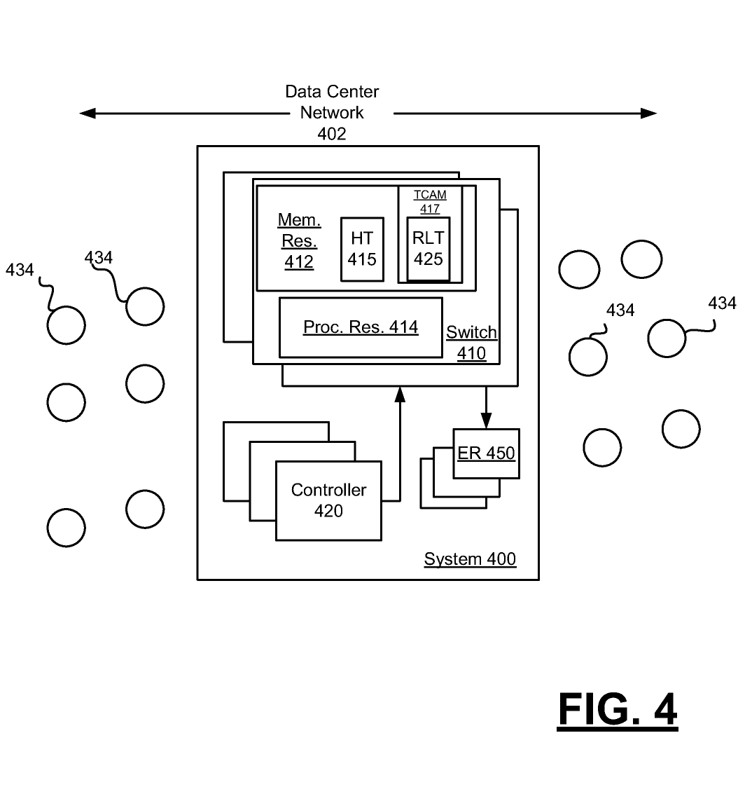

In a variation, the system 100 can handle packets 11 that specify IP source or destination addresses outside the known network, by the use of a second lookup table 125. If one or both of the source IP address and destination IP address are not found in conversion table 116, then the key conversion component 114 may signal a conversion failure to the key extraction component 116. Upon receiving a signal of conversion failure, the key extraction component 112 may transmit the original flow key 113 to a secondary lookup component 121, instead of transmitting the compacted flow key 111 to lookup component 120. The secondary lookup component 121 may use the original flow key 113 to determine a flow rule number using the second lookup table 125. While the secondary lookup table 125 may use a wider TCAM than lookup table 124, the second lookup table 125 may require far fewer rows than lookup table 124, yielding an overall reduction in the amount of TCAM space over conventional approaches. Lookup component 120 and secondary lookup component 121 may optionally be operated in parallel, in order to increase performance. As is known in the art, specialized rules for forwarding to external nodes and for applying access controls involving external nodes may be implemented in a separate switch (e.g., see external routers 450 in FIG. 4) that is dedicated for this purpose, rather than being implemented in every switch in the data center, thus allowing a relatively small number of rows in second lookup table 125.

With regard to an example system of FIG. 1, among other benefits, examples described herein provide cost savings, particularly as to the use of lookup tables (e.g., conversion table 116, lookup tables 124, 125). In particular, the rules in the lookup table 124 include multiple address fields, and each address or compact identifier can appear in multiple rules. For an N-address system (where N equals the number of addresses in use with the data center network), a maximum boundary scenario would require N×N TCAM entries, although the number of actual TCAM rules in use can be expected to be smaller than N×N. The number of bits (and consequently the total number of bits) involved in maintaining the conversion table 116 can be reduced over time if the conversion table is updated reactively or on demand. Additionally, the conversion table 116 can be constructed as a hash table, which can be cheaper than, for example, a TCAM.

Methodology

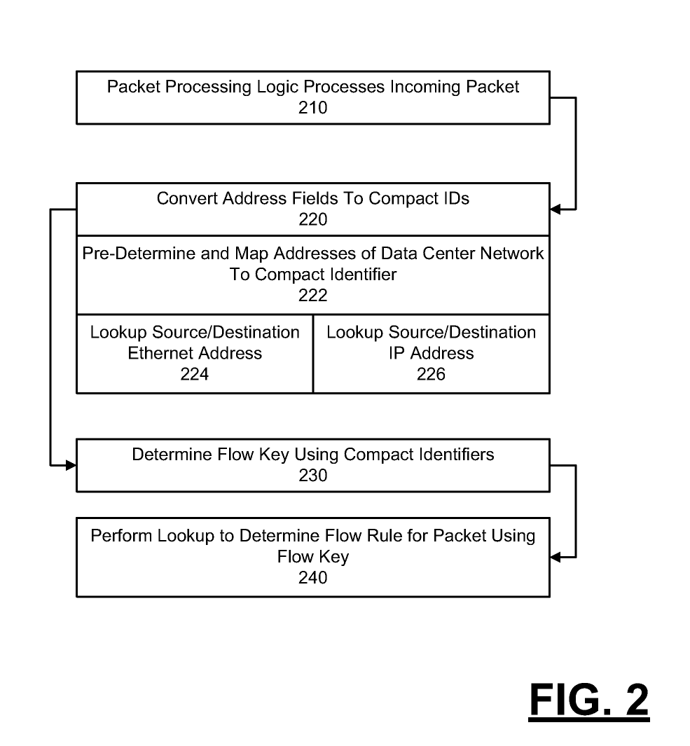

FIG. 2 illustrates an example method for handling data packets within a data center network. A method such as described by an example of FIG. 2 may be implemented using, for example, a system such as described by an example of FIG. 1. Accordingly, reference may be made to elements of an example system of FIG. 1 for purpose of illustrating suitable components for performing a step or sub-step being described.

With reference to FIG. 2, an incoming data packet may be processed using, for example, the packet processing logic 110 (210). The fields of the data packet can be extracted. The fields can include various address items, such as a source Ethernet address, a destination Ethernet address, a source IP address, and a destination IP address. In a variation, the address items can include delineations in the address fields, such as the subnet of the source IP address, the host of the source IP address, the subnet of the destination IP address, and the host of the destination IP address.

In an implementation, the address items are converted into compact identifiers (220). The bit sizes of the compact identifiers are smaller than the bit sizes of the address items which they represent. As described by examples of FIG. 1, the smaller size identifiers can enable a reduction in the size of the lookup table (e.g., TCAM) used to determine the flow rule for the incoming data packet. In one implementation, the addresses of each node in the data center network are predetermined and mapped to a compact identifier (222). More specifically, an example provides that the Ethernet source and destination addresses are converted to corresponding compact identifiers using the conversion table 116 (224). Likewise, the IP address and the IP source address for each node of the data center are mapped to a corresponding compact identifier using the conversion table 116 (226). As an addition or variation, as described with an example of FIG. 3, portions of the respective IP addresses can be identified and paired to respective compact identifiers in order to handle wildcard designations.

The compact identifiers are used to determine the flow key for the incoming data packet (230). In particular, the compact identifiers can be used in place of the Ethernet and IP addresses extracted from the incoming packets. The flow key utilizing the compact identifiers is then used to determine the flow rule for the incoming data packet (240). Amongst other benefits, the use of compact identifiers in place of address fields allows for a smaller flow key, as well as a smaller lookup table from which the flow rule is determined.

Wildcards

FIG. 3 illustrates an example method for handling data packets with wildcard designations in a data center network. A method such as described by an example of FIG. 3 may be implemented using, for example, a system such as described by an example of FIG. 1. Accordingly, reference may be made to elements of an example system of FIG. 1 for purpose of illustrating suitable components for performing a step or sub-step being described.

Data packets may be received by switch 100 (310). Each data packet received by the switch 100 may be processed to extract a set of fields (320). As an example, the set of fields can include source and destination Ethernet addresses, source and destination IP addresses, TCP port number, bit fields that identify whether the packet is communicated under TCP/IP or UDP protocol, bit fields that identify the VLAN number the packet was received on, the switch port number and other fields.

Each of the respective source and destination Ethernet addresses specified in the set of fields can be converted into compact identifiers (330). The compact identifiers may, for example, range in size between 15-24 bits, as compared to the 48 bit Ethernet addresses.

Optionally, each of the Ethernet addresses that are specified in the packet 11 is inspected to determine whether a bit of the address designates unicast or multicast. In examples described herein, the conversion process for the address fields is performed when the Ethernet addresses specify that the data packet is unicast, in which case each of the source and destination Ethernet address can be converted into a corresponding compact identifier. Additionally, in the event of an IP-multicast designation, the Ethernet address chosen as the destination multicast address can be selected by a deterministic algorithm. In such a variation, the Ethernet and IP multicast address can be compacted even further as compared to the typical unicast case.

Each of the respective source and destination IP addresses may also be subjected to a conversion process (340). A conversion process of an example of FIG. 3 may provide for wildcard designations in portions of the respective source and destination IP addresses. In one implementation, the delineation in the IP addresses between subnet and host are identified for the particular data center network (342). For example, the controller 130 can determine the prefix based on the assumption that a small number of prefixes are in use in the data center network. In some implementations, a logical component can be used to determine an appropriate prefix length for an address specified in the packet 11 (e.g., see prefix length 108 and associated logic FIG. 1). The delineation between subnet and host can be known to, for example, the controller 130 (see FIG. 1) of the data center network. Thus, in addition to the switch 100 (see FIG. 1) having knowledge of each node address (from data provided by the controller 130), the switch 100 may also know the subdivision between the subnet and host portions of the IP addresses.

If it is desirable to support wildcard lookups in lookup table 124 that allow wildcard matches against either the prefix, or suffix, or both, of an IP address, then both the prefix and suffix portions of the IP address are converted into compact identifiers (346). In one implementation, a source address prefix length is determined from the source Internet Protocol address, and a destination address prefix length is determined from the destination Internet Protocol address. Each of a source Internet Protocol address prefix and a source Internet address suffix can be determined using the source address prefix length and the source Internet Protocol Address. Additionally, each of a destination Internet Protocol address prefix and a destination Internet Protocol address suffix can be determined using the destination address prefix length and the destination Internet Protocol Address. In variations, each prefix and suffix can be separately converted in order to support wildcard lookups in table 124. Otherwise, the entire IP address is converted into a single compact identifier.

The flow key is determined using, in part, the various identifiers that are determined for the address items (350). More specifically, the flow key is determined from the compact identifiers of the converted address items (e.g., source/destination Ethernet address and subnet/host portions of the IP address), as well as from non-address fields extracted from the packet. Thus, in the example provided, up to six (6) compact identifiers may be determined for extracted address items corresponding to each of the Ethernet source address, the Ethernet destination address, the prefix portion (e.g., subnet) of the source IP address, the suffix portion (e.g., host) of the source IP address, the prefix portion (e.g., subnet) of the destination IP address, the suffix portion (e.g., host) of the destination IP address. As described with an example of FIG. 2, the address items corresponding to subnet and host portions of the IP addresses for each discovered node can be determined and singularly mapped to a corresponding compact identifier. In this way, individual packets can be analyzed, and their source/destination IP addresses can be converted into compact identifiers using, for example, the conversion table 116. The flow key 111 can be constructed based at least in part on the conversion values determined for the addresses, including those determined for the subnet (prefix) and host (suffix) portions of the individual source and destination IP addresses.

The flow key can then be used to identify a flow rule for the packet (360). The flow rule can be determined by, for example, performing a lookup on a rule or lookup table 124 to obtain a flow rule number 123, which can then be used to look up actions 151 to be applied to packets match that flow rule. By using compact identifiers, the lookup table 124 can be reduced in size. As such, the hardware resources (e.g., TCAM) for effectively implementing the lookup table 124 can be reduced, thereby conserving resources (e.g., power) and costs (such as would be incurred by larger TCAMs). As the use of TCAMs can be considerably more expensive than use of other kinds of memory resources (e.g., for implementing the conversion table 116), the reduction in the use of TCAM hardware can provide an overall cost savings.

Hardware System

FIG. 4 illustrates an example hardware system for implementing examples such as described. A system 400 includes one or more switches 410, and one or more controllers 420. The system 400 can be implemented in the context of a data center network. The controller 420 can utilize discovery resources to identify individual physical and/or virtual nodes 434 that exist within the data center network. As examples, the data center network can correspond to a data center network 402 that maintains various physical and virtual machines as nodes 434. While some examples such as shown with FIG. 4 reference a system with separate switches and controllers, variations of examples described herein can be implemented in systems in which the control and data plane are on the same device.

In one implementation, the controller 420 may include software or programming for implementing a software defined network, such as provided through the OpenFlow protocol. Likewise, the switch 410 can be configured to communicate with the controller 420 in order to implement, for example, an OpenFlow protocol.

The switch 410 includes memory resources 412 and processing resources 414. The switch 410 can be configured to retain a hash table 415 that maintains a mapping as between the various address items of the discovered nodes on the data center network 402. The data for the hash table 415 can be received from the controller 420. The controller 420 can include, or utilize, functionality for performing discovery or identification of the individual nodes 434. The processing resources 414 can implement functionality such as described by an example of FIG. 1. Accordingly, the combination of the memory resources 412 and processing resources 414 can (i) process packets, (ii) extract fields from the packets, identify address items (e.g., source and destination Ethernet addresses, subnet and host portions of source and destination IP addresses) from the extracted fields, and (iii) perform conversions that result in identifiers that are smaller in bit size than the corresponding address items. The combination of the memory and processing resources 412, 414 can further determine flow keys from the extracted fields of the processed packets, except as described herein, the flow key is determined using compact identifiers in place of converted address items.

The memory resources 412 of the switch can include a flow rule lookup table 425, which can be implemented by, for example, a TCAM 417. The processing resources 414 can utilize the flow rule lookup table 425 to determine the flow rule corresponding to the data packet.

In some implementations, a small set of external routers 450 may handle detailed access control and external routing for packets that specify IP source or destination addresses outside the known network. As described with an example of FIG. 1, the external routers 450 can be implemented to have a relatively smaller number of rows.

Although illustrative examples have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an example, can be combined with other individually described features, or parts of other examples. Thus, absence of describing combinations should not preclude the inventor(s) from claiming rights to such combinations.

What is claimed is:

1. A switch for a data center network, the switch comprising:
a memory to store a hash table, the hash table including (i) a plurality of address items for nodes of the data center network, and (ii) an identifier corresponding to each address item in the plurality of address items, each identifier having a smaller bit size than its corresponding address item, and each address item corresponding to at least a portion of an address; and
a processing resource to:
extract a set of fields from received data packets, the set of fields including a set of address items;
use the hash table to convert each of at least some of the address items in the set of address items into a corresponding identifier; and
determine a flow key for each of the received packets based at least in part on (i) at least some of the set of fields extracted for that data packet, and (ii) the corresponding identifier for each converted address items for that data packet.

2. The switch of claim 1, wherein the processing resource extracts, for each received data packet, a set of address items that includes a source Ethernet address, a destination Ethernet address, at least a portion of a source Internet Protocol address, and at least a portion of a destination Internet Protocol address, and wherein the processing resource (i) determines the corresponding identifier for the source Ethernet address, (ii) determines the corresponding identifier for the destination Ethernet address, (iii) determines the corresponding identifier for at least the portion of the source Internet Protocol address, and (iv) determines the corresponding identifier for at least the portion of the destination Internet Protocol address.

3. The switch of claim 2, wherein for each received data packet, the set of address items include a prefix portion of the source Internet Protocol address, a suffix portion of the source Internet Protocol address, a prefix portion of the destination Internet Protocol address, and a suffix portion of the destination Internet Protocol address.

4. The switch of claim 1, wherein the corresponding identifier for each address item is less than 24 bits in size.

5. The switch of claim 1, wherein the hash table receives the plurality of address items and the identifier corresponding to each address item in the plurality of address items from a controller.

6. The switch of claim 1, wherein the processing resource is configured, for each received data packet, to:
determine at least a source Internet Protocol address and a destination Internet Protocol address from the set of fields,
determine a source address prefix length from the source Internet Protocol address and a destination address prefix length from the destination Internet Protocol address:
determine (i) a source Internet Protocol address prefix and a source Internet address suffix using the source address prefix length and the source Internet Protocol Address, and (ii) a destination Internet Protocol address prefix and a destination Internet Protocol address suffix using the destination address prefix length and the destination Internet Protocol Address.

7. The switch of claim 6, wherein the processing resources determine the flow key for each received packet using, in part, the corresponding identifier for the portion of the source Internet Protocol address or the destination Internet Protocol address.

8. The switch of claim 1, wherein the switch is an OpenFlow switch.

9. A method for handling a data packet on a switch of a data center network, the method being implemented by one or more processors and comprising:
(a) determining a plurality of fields that are included in a data packet that is received at the switch, the plurality of fields including a set of address items, and each address item corresponding to at least a portion of an address;
(b) identifying an identifier that is singularly associated with each address item in the set of address items, the identifier having fewer bits than the associated address item;
(c) determining a flow key for the data packet using (i) at least some of the plurality of fields, and (ii) the identifier associated with each address item in the set of address items, in place of the associated address item.

10. The method of claim 9, wherein each identifier is pre-associated with the associated address item.

11. The method of claim 9, wherein the set of address items includes at least one Ethernet address and at least a portion of one Internet Protocol address, and wherein (b) includes determining an identifier for the at least one Ethernet address, and an identifier for the portion of the at least one Internet Protocol address.

12. The method of claim 11, further comprising determining a subnet portion and a host portion for Internet Protocol addresses assigned to nodes of the data center network, and wherein determining the identifier for the portion of the at least one Internet Protocol address includes determining the identifier for at least one of the subnet portion or the host portion of the at least one Internet Protocol address.

13. The method of claim 12, wherein the set of address items includes a source Ethernet address, a destination Ethernet address, a host portion of a source IP address, a subnet portion of a source IP address, a host portion of a destination IP address, and subnet portion of a destination address.

14. The method of claim 9,
wherein (a) includes determining the set of address items corresponding to at least a source Internet Protocol address and a destination Internet Protocol address; and
wherein (b) includes:
determining a source address prefix length from a source Internet Protocol address and a destination address prefix length from a destination Internet Protocol address:
determining (i) a source Internet Protocol address prefix and a source Internet address suffix using the source address prefix length and the source Internet Protocol Address, and (ii) a destination Internet Protocol address prefix and a destination Internet Protocol address suffix using the destination address prefix length and the destination Internet Protocol Address.

15. A system for a data center network, the system comprising:
a controller; and
a network switch, the network switch comprising:
a memory to store a hash table, the hash table including (i) a set of address items for nodes of the data center network, and (ii) an identifier corresponding to each address item in the set of address items, each identifier having fewer bits than its corresponding address item;
a processing resource to:
extract a set of fields from received data packets, the set of fields including a set of address items;
use the hash table to convert each of at least some of the address items in the set of address items into a corresponding identifier; and
determine a flow key for each of the received packets based on (i) at least some of the set of fields extracted for that data packet, and (ii) the corresponding identifier for each converted address items for that data packet.
